(19) United States
(12) Patent Application Publication
(10) Pub. No.: US 2007/0135610 A1
(43) Pub. Date: Jun. 14, 2007

(54) Polyarylate acid chloride compositions and derivatives therefrom

(75) Inventors: Rainer Koeniger, Clifton Park, NY (US); Michael Jeffrey McLaughlin, Albany, NY (US); Glen David Merfeld, Loudonville, NY (US)

Correspondence Address: Andrew J. Caruso;General Electric Global Research, Docket Room K1-4A59, One Research Circle, Niskayuna, NY, 12309, US

(73) Assignee: General Electric Company, Schenectady, NY (US)

(21) Appl. No.: 11/299,252

(22) Filed: Dec. 9, 2005

(51) Int. Cl. C08G 8/02

(52) U.S. Cl. 528/125

(57) ABSTRACT

Disclosed herein are polyarylate acid chloride compositions derived from aromatic diacid chlorides and dihydroxy aromatic compounds that are made by reacting a stoichiometric excess of said aromatic diacid chlorides with the dihydroxy aromatic compounds. Disclosed also are a wide variety of compositions derived from said polyarylate acid chlorides. In one instance new compositions are prepared by reacting the polyarylate acid chlorides with a nucleophile containing carboxylate functionality to provide an acid end-capped polyarylate. Alternately, the polyarylate acid chlorides may be hydrolyzed to provide carboxylate end-capped polyarylates. Disclosed further are methods to make described compositions.

### BACKGROUND

The invention relates generally to polyarylate acid chloride compositions. More particularly, the invention relates to compositions derived from polyarylate acid chloride compositions, with carboxylate functionalized nucleophiles.

Modern commerce and technology frequently employ organic coatings to shield various sensitive substrates from the harmful effects of the environment. Many such coatings are limited by long-term color instability, a limitation which is evidenced by a yellowing of the organic coating over time. Yellowing due to a coating's constituent polymeric components may be caused by the action of ultraviolet (UV) radiation. Another frequently encountered problem with organic coatings based on polymeric materials is poor resistance of the coating to chemicals and solvents after its application. Coatings which are tough, chemically resistant and “weatherable” (i.e. resistant to the effects of sunlight and other environmental conditions) are highly prized and diligently sought after.

Generally it has been observed that there is a tradeoff between weatherability and toughness in the performance of the commercial coating compositions known in the art. One solution to this problem has been the combination of extremely tough epoxies with aromatic polyesters (polyarylates) to provide coatings with improved weatherability. Similarly acrylates, which are known to exhibit good weatherability, but poor toughness, have been combined with polyester resins to improve their toughness. Compositions containing polyoxymethylene resins and various additives to improve toughness or impact strength are also known but performance limitations remain nonetheless.

Therefore there exists a need for new polymeric compositions possessing enhanced performance characteristic relative to known materials. In particular, it would be desirable to provide novel aromatic polyester building blocks for use in the preparation of coating materials possessing enhanced performance characteristics.

### BRIEF DESCRIPTION

In one aspect, the invention provides a polyarylate acid chloride comprising at least one arylate structural unit having formula I 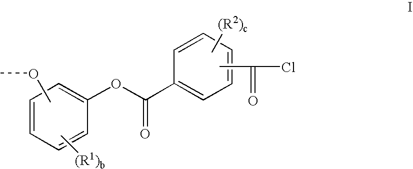
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate having a number average molecular weight in a range form about 500 to about 4000 grams per mole, said polyarylate having an acid chloride value in a range from about 500 to about 2000 micro equivalents per gram.

In another aspect, the invention provides a composition comprising structural units derived from a polyarylate acid chloride having formula I 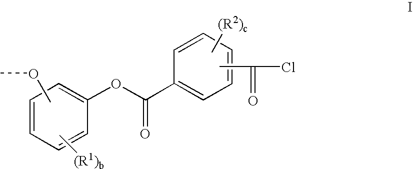
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate acid chloride having a number average molecular weight in a range form about 500 to about 4000 grams per mole, said polyarylate having an acid chloride value in a range from about 500 to about 2000 micro equivalents per gram.

In yet another aspect, the invention provides a method for preparing a polyarylate acid chloride comprising structural units having formula I 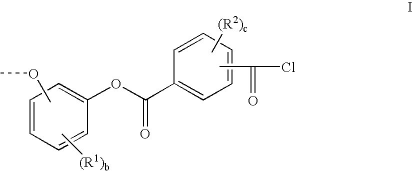
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate having a weight average molecular weight in a range form about 500 to about 4000 grams per mole, said polyarylate having an acid chloride value in a range from about 500 to about 2000 micro equivalents per gram;
said method comprising:

(a) providing a first solution of at least one diacid chloride, an organic phase transfer catalyst, and at least one substantially water immiscible solvent;

(b) contacting said first solution with an aqueous solution comprising at least one dihydroxy aromatic compound and at least one metal hydroxide, said at least one dihydroxy aromatic compound being used in an amount such that the at least one diacid chloride is in stoichiometric excess relative to the amount of the dihydroxy aromatic compound used, said metal hydroxide being used in an amount corresponding to a stoichiometric excess relative to the amount of the dihydroxy aromatic compound used, to provide a product mixture said product mixture comprising a brine phase and an organic phase; and

(c) separating said brine phase and said organic phase to provide a solution of the product polyarylate acid chloride.

In a further aspect, the invention provides a method for preparing an end-capped polyarylate composition comprising structural units having formula-II 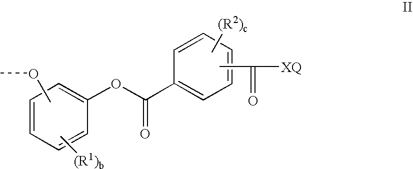
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, CN, OH, OOH, NCO, or NCS; and R³ is a C₁-C₂₀ aliphatic radical, a C₃-C₂₀ cycloaliphatic radical, or a C₂-C₂₀ aromatic radical;
said method comprising:

(a) providing a first solution of at least one diacid chloride, an organic phase transfer catalyst, and at least one substantially water immiscible solvent;

(b) contacting said first solution with an aqueous solution comprising at least one dihydroxy aromatic compound and at least one metal hydroxide, said at least one dihydroxy aromatic compound being used in an amount such that the at least one diacid chloride is in stoichiometric excess relative to the amount of the dihydroxy aromatic compound used, said metal hydroxide being used in an amount corresponding to a stoichiometric excess relative to the amount of the dihydroxy aromatic compound used, to provide a product mixture said product mixture comprising an brine phase and an organic phase;

(c) separating said brine phase and said organic phase to provide a solution of the product polyarylate acid chloride, said polyarylate acid chloride having a weight average molecular weight in a range form about 500 to about 4000 grams per mole, said polyarylate having an acid chloride value in a range from about 500 to about 2000 micro equivalents per gram; and

(d) contacting said polyarylate acid chloride with at least one nucleophile having structure VII
BXQ VII
wherein B is a negative charge, H, or (R⁷)₃Si; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, CN, OH, OOH, NCO, or NCS; R³ is a C₁-C₂₀ aliphatic radical, a C₃-C₂₀ cycloaliphatic radical, or a C₂-C₂₀ aromatic radical; and R⁷ is independently at each occurrence a C₁-C₂₀ aliphatic radical, a C₃-C₂₀ cycloaliphatic radical, or a C₂-C₂₀ aromatic radical.

### DETAILED DESCRIPTION

The present invention may be understood more readily by reference to the following detailed description of preferred embodiments of the invention and the examples included therein. In the following specification and the claims which follow, reference will be made to a number of terms which shall be defined to have the following meanings:

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

The modifier “about” used in connection with a quantity is inclusive of the stated value and has the meaning dictated by the context (e.g., includes the degree of error associated with measurement of the particular quantity).

As used herein, the term “aromatic radical” refers to an array of atoms having a valence of at least one comprising at least one aromatic group. The array of atoms having a valence of at least one comprising at least one aromatic group may include heteroatoms such as nitrogen, sulfur, selenium, silicon and oxygen, or may be composed exclusively of carbon and hydrogen. As used herein, the term “aromatic radical” includes but is not limited to phenyl, pyridyl, furanyl, thienyl, naphthyl, phenylene, and biphenyl radicals. As noted, the aromatic radical contains at least one aromatic group. The aromatic group is invariably a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthraceneyl groups (n=3) and the like. The aromatic radical may also include nonaromatic components. For example, a benzyl group is an aromatic radical which comprises a phenyl ring (the aromatic group) and a methylene group (the nonaromatic component). Similarly a tetrahydronaphthyl radical is an aromatic radical comprising an aromatic group (C₆H₃) fused to a nonaromatic component —(CH₂)₄—. For convenience, the term “aromatic radical” is defined herein to encompass a wide range of functional groups such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters, carbonate groups, and amides), amine groups, nitro groups, and the like. For example, the 4-methylphenyl radical is a C₇ aromatic radical comprising a methyl group, the methyl group being a functional group which is an alkyl group. Similarly, the 2-nitrophenyl group is a C₆ aromatic radical comprising a nitro group, the nitro group being a functional group. Aromatic radicals include halogenated aromatic radicals such as 4-trifluoromethylphenyl, hexafluoroisopropylidenebis(4-phen-1-yloxy) (i.e., —OPhC(CF₃)₂PhO—), 4-chloromethylphen-1-yl, 3-trifluorovinyl-2-thienyl, 3-trichloromethylphen-1-yl (i.e., 3-CCl₃Ph-), 4-(3-bromoprop-1-yl)phen-1-yl (i.e., 4-BrCH₂CH₂CH₂Ph-), and the like. Further examples of aromatic radicals include 4-allyloxyphen-1-oxy, 4-aminophen-1-yl (i.e., 4-H₂NPh-), 3-aminocarbonylphen-1-yl (i.e., NH₂COPh-), 4-benzoylphen-1-yl, dicyanomethylidenebis(4-phen-1-yloxy) (i.e., —OPhC(CN)₂PhO—), 3-methylphen-1-yl, methylenebis(4-phen-1-yloxy) (i.e., —OPhCH₂PhO—), 2-ethylphen-1-yl, phenylethenyl, 3-formyl-2-thienyl, 2-hexyl-5-furanyl, hexamethylene-1,6-bis(4-phen-1-yloxy) (i.e., —OPh(CH₂)₆PhO—), 4-hydroxymethylphen-1-yl (i.e., 4-HOCH₂Ph-), 4-mercaptomethylphen-1-yl (i.e., 4-HSCH₂Ph-), 4-methylthiophen-1-yl (i.e., 4-CH₃SPh-), 3-methoxyphen-1-yl, 2-methoxycarbonylphen-1-yloxy (e.g., methyl salicyl), 2-nitromethylphen-1-yl (i.e., 2-NO₂CH₂Ph), 3-trimethylsilylphen-1-yl, 4-t-butyldimethylsilylphenl-1-yl, 4-vinylphen-1-yl, vinylidenebis(phenyl), and the like. The term “a C₃-C₁₀ aromatic radical” includes aromatic radicals containing at least three but no more than 10 carbon atoms. The aromatic radical 1-imidazolyl (C₃H₂N₂—) represents a C₃ aromatic radical. The benzyl radical (C₇H₇—) represents a C₇ aromatic radical.

As used herein the term “cycloaliphatic radical” refers to a radical having a valence of at least one, and comprising an array of atoms which is cyclic but which is not aromatic. As defined herein a “cycloaliphatic radical” does not contain an aromatic group. A “cycloaliphatic radical” may comprise one or more noncyclic components. For example, a cyclohexylmethyl group (C₆H₁₁CH₂—) is an cycloaliphatic radical which comprises a cyclohexyl ring (the array of atoms which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. For convenience, the term “cycloaliphatic radical” is defined herein to encompass a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters, carbonate groups, and amides), amine groups, nitro groups, and the like. For example, the 4-methylcyclopent-1-yl radical is a C₆ cycloaliphatic radical comprising a methyl group, the methyl group being a functional group which is an alkyl group. Similarly, the 2-nitrocyclobut-1-yl radical is a C₄ cycloaliphatic radical comprising a nitro group, the nitro group being a functional group. A cycloaliphatic radical may comprise one or more halogen atoms which may be the same or different. Halogen atoms include, for example; fluorine, chlorine, bromine, and iodine. Cycloaliphatic radicals comprising one or more halogen atoms include 2-trifluoromethylcyclohex-1-yl, 4-bromodifluoromethylcyclooct-1-yl, 2-chlorodifluoromethylcyclohex-1-yl, hexafluoroisopropylidene-2,2-bis(cyclohex-4-yl) (i.e., —C₆H₁₀C(CF₃)₂C₆H₁₀—), 2-chloromethylcyclohex-1-yl, 3-difluoromethylenecyclohex-1-yl, 4-trichloromethylcyclohex-1-yloxy, 4-bromodichloromethylcyclohex-1-ylthio, 2-bromoethylcyclopent-1-yl, 2-bromopropylcyclohex-1-yloxy (e.g., CH₃CHBrCH₂C₆H₁₀O—), and the like. Further examples of cycloaliphatic radicals include 4-allyloxycyclohex-1-yl, 4-aminocyclohex-1-yl (i.e., H₂NC₆H₁₀—), 4-aminocarbonylcyclopent-1-yl (i.e., NH₂COC₅H₈—), 4-acetyloxycyclohex-1-yl, 2,2-dicyanoisopropylidenebis(cyclohex-4-yloxy) (i.e., —OC₆H₁₀C(CN)₂C₆H₁₀O—), 3-methylcyclohex-1-yl, methylenebis(cyclohex-4-yloxy) (i.e., —OC₆H₁₀CH₂C₆H₁₀O—), 1-ethylcyclobut-1-yl, cyclopropylethenyl, 3-formyl-2-terahydrofuranyl, 2-hexyl-5-tetrahydrofuranyl, hexamethylene-1,6-bis(cyclohex-4-yloxy) (i.e., —O C₆H₁₀(CH₂)₆C₆H₁₀O—), 4-hydroxymethylcyclohex-1-yl (i.e., 4-HOCH₂C₆H₁₀—), 4-mercaptomethylcyclohex-1-yl (i.e., 4-HSCH₂C₆H₁₀—), 4-methylthiocyclohex-1-yl (i.e., 4-CH₃SC₆H₁₀—), 4-methoxycyclohex-1-yl, 2-methoxycarbonylcyclohex-1-yloxy(2-CH₃OCOC₆H₁₀O—), 4-nitromethylcyclohex-1-yl (i.e., NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g., (CH₃O)₃SiCH₂CH₂C₆H₁₀—), 4-vinylcyclohexen-1-yl, vinylidenebis(cyclohexyl), and the like. The term “a C₃-C₁₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

As used herein the term “aliphatic radical” refers to an organic radical having a valence of at least one consisting of a linear or branched array of atoms which is not cyclic. Aliphatic radicals are defined to comprise at least one carbon atom. The array of atoms comprising the aliphatic radical may include heteroatoms such as nitrogen, sulfur, silicon, selenium and oxygen or may be composed exclusively of carbon and hydrogen. For convenience, the term “aliphatic radical” is defined herein to encompass, as part of the “linear or branched array of atoms which is not cyclic” a wide range of functional groups such as alkyl groups, alkenyl groups, alkynyl groups, haloalkyl groups, conjugated dienyl groups, alcohol groups, ether groups, aldehyde groups, ketone groups, carboxylic acid groups, acyl groups (for example carboxylic acid derivatives such as esters, carbonate groups, and amides), amine groups, nitro groups, and the like. For example, the 4-methylpent-1-yl radical is a C₆ aliphatic radical comprising a methyl group, the methyl group being a functional group which is an alkyl group. Similarly, the 4-nitrobut-1-yl group is a C₄ aliphatic radical comprising a nitro group, the nitro group being a functional group. An aliphatic radical may be a haloalkyl group which comprises one or more halogen atoms which may be the same or different. Halogen atoms include, for example; fluorine, chlorine, bromine, and iodine. Aliphatic radicals comprising one or more halogen atoms include the alkyl halides trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (i.e., —CONH₂), carbonyl, 2,2-dicyanoisopropylidene (i.e., —CH₂C(CN)₂CH₂—), methyl (i.e., —CH₃), methylene (i.e., —CH₂—), ethyl, ethylene, formyl (i.e., —CHO), hexyl, hexamethylene, hydroxymethyl (i.e., —CH₂OH), mercaptomethyl (i.e., —CH₂SH), methylthio (i.e., —SCH₃), methylthiomethyl (i.e., —CH₂SCH₃), methoxy, methoxycarbonyl (i.e., CH₃OCO—), nitromethyl (i.e., —CH₂NO₂), thiocarbonyl, trimethylsilyl (i.e., (CH₃)₃Si—), t-butyldimethylsilyl, 3-trimethyoxysilypropyl (i.e., (CH₃O)₃SiCH₂CH₂CH₂—), vinyl, vinylidene, and the like. By way of further example, a C₁-C₁₀ aliphatic radical contains at least one but no more than 10 carbon atoms. A methyl group (i.e., CH₃—) is an example of a C₁ aliphatic radical. A decyl group (i.e., CH₃(CH₂)₉—) is an example of a C₁₀ aliphatic radical.

As noted, the invention provides a polyarylate acid chloride comprising at least one arylate structural unit having formula I 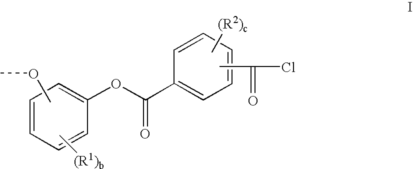
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate having a number average molecular weight in a range from about 500 to about 4000 grams per mole, said polyarylate having an acid chloride value in a range from about 500 to about 2000 micro equivalents per gram.

In one embodiment the polyarylate acid chloride comprising at least one structural unit having formula I, is derived from a dihydroxy aromatic compound and an aromatic dicarboxylic acid halide. In one particular embodiment the dihydroxy aromatic compound is a 1,3-dihydroxybenzene compound having formula IX, commonly referred to throughout this specification as resorcinol or a resorcinol derivative. 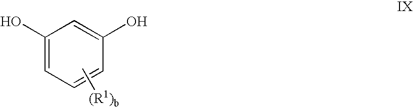
In formula IX, R¹ is independently at each occurrence a halogen atom, a nitro group, a C₁-C₂₀ aliphatic radical, a C₃-C₂₀ cycloaliphatic radical, or a C₃-C₂₀ aromatic radical; and “b” is an integer having a value 0 to 4. “Resorcinol” or “resorcinol derivative” as used within the context of the present invention should be understood to include both unsubstituted (b=0) 1,3-dihydroxybenzene and substituted (b is 1 to 4) 1,3-dihydroxybenzenes unless explicitly stated otherwise. Suitable R¹ groups include, but are not limited to methyl, trifluoromethyl, ethyl, n-propyl, isopropyl, butyl, iso-butyl, t-butyl, hexyl, cyclohexyl, nonyl, decyl, and benzyl. In one particular embodiment wherein R¹ is methyl and “b” is 1, the compound of formula IX is 2-methyl resorcinol. In another embodiment in which “b” is zero, the resorcinol compound having formula IX, is unsubstituted resorcinol.

Suitable aromatic dicarboxylic acid halides include monocyclic aromatic dicarboxylic acid halides X 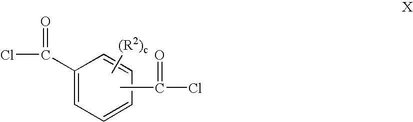
wherein R² is a halogen atom, a nitro group, a C₁-C₂₀ aliphatic radical, a C₃-C₂₀ cycloaliphatic radical, or a C₃-C₂₀ aromatic radical; “c” is an integer having a value 0 to 4; and polycyclic aromatic dicarboxylic acid halides. Exemplary monocyclic aromatic dicarboxylic acid chlorides include isophthalic acid chloride (also referred to as isophthaloyl chloride and isophthaloyl dichloride), terephthalic acid chloride (also referred to as terephthaloyl chloride and terephthaloyl dichloride), and mixtures of the foregoing monocyclic aromatic dicarboxylic acid chlorides. Exemplary polycyclic aromatic dicarboxylic acid chlorides include, but are not limited to, biphenyl-4,4′-dicarboxylic acid chloride; 4,5-chrysene-dicarboxylic acid chloride; dihydro-pyrene-carboxylic acid chloride; phenanthrene 4,5-dicarboxylic acid chloride, naphthalene-1,4-dicarboxylic acid chloride, and anthracene-1,5-dicarboxylic acid chloride.

In various embodiments, the polyarylate acid chlorides of the present invention comprise arylate structural units derived from resorcinol (or a resorcinol derivative) and mixtures of isophthalic and terephthalic acid chlorides. Polyarylate acid chlorides can be prepared by reacting a molar excess of at least one aromatic dicarboxylic acid chloride with at least one dihydroxy aromatic compound under interfacial reaction conditions. The term “interfacial reaction conditions” as used herein encompasses a variety of ways of making both polyarylate acid chloride intermediates and derivatives thereof, such as polyarylate compositions comprising structural units II. Generally, interfacial conditions are illustrated by reactions in which the reactants are present in a two phase reaction mixture comprising water, a water immiscible solvent such as methylene chloride, a water soluble metal hydroxide (for example an alkali metal hydroxide such as sodium hydroxide), and optionally an organic phase transfer catalyst. Typically, interfacial reaction conditions involve reaction at or near ambient temperature, for example at a temperature in a range between about 10° C. and about 60° C., although other temperature ranges are possible. In one embodiment, the polyarylate acid chloride is prepared by reacting a molar excess of isophthaloyl dichloride and terephthaloyl dichloride with resorcinol under interfacial reaction conditions.

As noted, in various embodiments the arylate component of the polyarylate polymers of the present invention may be prepared from a mixture of dicarboxylic acid dichlorides. In one embodiment, a mixture of isophthaloyl and terephthaloyl dichlorides in a molar ratio of isopthaloyl to terephthaloyl of about 0.25-4:1 is used; in another embodiment the molar ratio is about 0.4:2.5:1; and in yet another embodiment the molar ratio is about 0.6-1.5:1.

In one embodiment, the compositions of the present invention comprise at least one polyarylate structural unit derived from resorcinol or a resorcinol derivative having formula IX and structural units derived from a mixture of iso- and terephthaloyl chloride, said polyarylate structural units being at times referred to as the “ITR units” or “ITR blocks”. With reference to the term “ITR”, the letter “I” refers to isophthaloyl groups, the letter “T” terephthaloyl groups, and the letter “R” groups derived from resorcinol or a derivative of resorcinol. Therefore in one embodiment, the present invention provides a polymeric composition comprising an ITR block comprising structural units represented by formula VIII 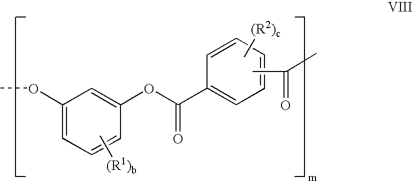
wherein the brackets indicate (as those skilled in the art will appreciate) that the structure VIII is a repeat unit of a polyarylate block having a block-length of “m”, and wherein R¹, R², “b” and “c” are defined as in formula I, and wherein “m” is a number from about 2 to about 15.

In certain embodiments structural units derived from one or more aliphatic diols may also be present in the polyarylate acid chloride polymer. Suitable aliphatic diols include 1,6-hexanediol, ethylene glycol, di-ethylene glycol, dipropylene glycol, propylene glycol, 1,2-butane diol, 1,3-butane diol, 1,4-butanediol, 2,2-bis(hydroxymethyl)propionic acid, polycaprolactone diol, neopentyl glycol, mixtures of said diols, and the like. Aliphatic diols may be used to modify the material properties (e.g. control melt viscosity and Tg) of the product polyarylate acid chloride. In one embodiment, the product polyarylate acid chloride comprises structural units derived from one or more aliphatic diols, said structural units being present in an amount corresponding to from about 0.01 percent by weight to about 90 percent by weight based on the total weight of the product polyarylate acid chloride polymer. In another embodiment, the product polyarylate acid chloride polymer comprises structural units derived from one or more aliphatic diols, said structural units being present in an amount corresponding to from about 0.1 percent by weight to about 25 percent by weight based on the total weight of the product polyarylate acid chloride. In yet another embodiment, the product polyarylate acid chloride comprises structural units derived from one or more aliphatic diols, said structural units being present in an amount corresponding to from about 1 percent by weight to about 2 percent by weight based on the total weight of the product polyarylate acid chloride.

In yet another embodiment, the polyarylate acid chloride has a number average molecular weight, Mₙ, in a range of from about 500 to about 4000 grams per mole. In yet still another embodiment, the polyarylate acid chloride has a number average molecular weight, Mₙ, in arrange of from about 500 to about 3000 grams per mole.

The polyarylate acid chloride of the invention are also characterized by having acid chloride value in the range from about 500 micro equivalents per gram to about 2000 micro equivalents per gram. As used herein, the term “acid chloride value” means mole equivalents of acid chloride groups contained in 1 gram of the polyarylate acid chloride. Acid chloride is determined by the titration of the acid chloride end groups with a suitable compound in the presence of a suitable indicator, for example a test medium sensitive to the presence of acid chloride groups such as the test paper typically used to signal the presence of low levels of phosgene present in a reaction mixture.

As also noted, in another embodiment, the invention provides a end-capped polyarylate composition comprising structural units having formula II 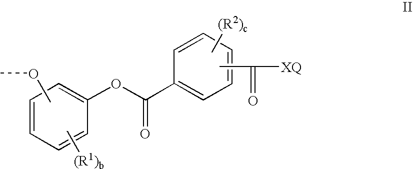
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, OH, OOH, NCO, or NCS; and R³ is a C₁-C₂₀ aliphatic radical, a C₃-C₂₀ cycloaliphatic radical, or a C₂-C₂₀ aromatic radical.

In one embodiment, the present invention provides an end-capped polyarylate comprising structural units having formula II, wherein XQ moieties are introduced by reacting the acid chloride with at least one nucleophile having structure VII
BXQ VII
wherein B is a negative charge, H, or (R⁷)₃Si; X is a bond, S, Se, O, NH, NR³, a divalent C₁-C₂₀ aliphatic radical, a divalent C₃-C₂₀ cycloaliphatic radical, divalent C₂-C₂₀ aromatic radical; Q is hydrogen, a C₁-C₂₀ aliphatic radical, a C₃-C₂₀ cycloaliphatic radical, C₂-C₂₀ aromatic radical, a polymer chain, NH₂, CN, OH, OOH, NCO, NCS; R³ is a C₁-C₂₀ aliphatic radical, a C₃-C₂₀ cycloaliphatic radical, or a C₂-C₂₀ aromatic radical; R³ is a C₁-C₂₀ aliphatic radical, a C₃-C₂₀ cycloaliphatic radical, or a C₂-C₂₀ aromatic radical; and R⁷ is independently at each occurrence a C₁-C₂₀ aliphatic radical, a C₃-C₂₀ cycloaliphatic radical, or a C₂-C₂₀ aromatic radical. Exemplary nucleophilic functional groups that may react with acid chloride groups include, but are not limited to, hydroxyls, amines, thiols, epoxy groups, and the like. In a particular embodiment, the XQ group comprises a pendant carboxylate group. The end-capped polyarylate composition comprising structural units having formula II are typically obtained by reacting the polyarylate acid chloride with an organic compound having a carboxylate functionality and a nucleophilic functional group.

In one embodiment, the XQ moiety has formula III 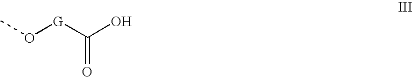
wherein G is a C₁-C₂₀ aliphatic radical, a C₃-C₂₀ cycloaliphatic radical, or a C₂-C₂₀ aromatic radical. Thus, the resulting end-capped polyarylate composition comprises structural units having formula XI 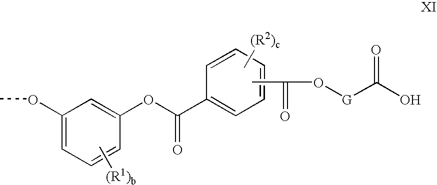
wherein R¹ and R², and “b” and “c” are as defined in formula II and G is as defined in formula III. The ester group (CO—O-G) present in the polyarylate comprising structural units XI may be generated by the reaction of a hydroxyl group on a hydroxy acid compound (HO-G-CO₂H) with the acid chloride group of the polyarylate acid chloride. Exemplary hydroxy acid compounds include, but are not limited to, 5-hydroxyisophthalic acid, hydroxybenzoic acid, salicylic acid, hydroxy caproic acid, lactic acid, glycolic acid, mandelic acid, 4-hydroxy-2-methylbenzoic acid, serine, tyrosine, desaminotyrosine, gluconic acid, glucaric acid, ascorbic acid, ω-hydroxy pentadecanoic acid, α-hydroxy-ω-carboxy polyethylene glycol, and combinations thereof. In one particular embodiment, the XQ moiety present in the polyarylate comprising structural units having formula II is derived from 5-hydroxyisophthalic acid and the moiety XQ has formula IV

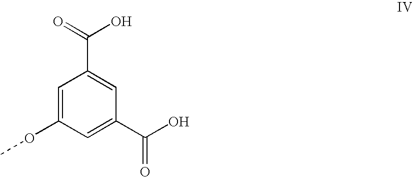

In another embodiment, the XQ moiety present in the polyarylate comprising structural units having formula II has formula V 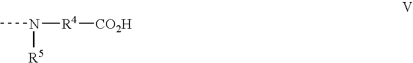
wherein R⁴ is a divalent C₁-C₂₀ aliphatic radical, a divalent C₃-C₂₀ cycloaliphatic radical, or a divalent C₃-C₂₀ aromatic radical; and R⁵ is hydrogen, a monovalent C₁-C₂₀ aliphatic radical, a monovalent C₃-C₂₀ cycloaliphatic radical, or a monovalent C₃-C₂₀ aromatic radical. Thus, the resulting end-capped polyarylate composition comprises structural units having formula XII 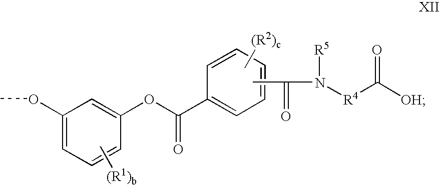
wherein R¹ and R², and “b” and “c” are as defined in formula II, and R⁴ and R⁵ are defined as in formula IV. The amide functional group (CO—NR⁵R⁴—) may generated by the reaction of an amine group of an amino acid with the acid chloride group of the polyarylate acid chloride. In one embodiment, R⁴ has formula VI 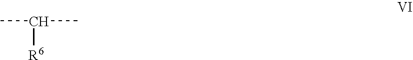
wherein R⁶ is hydrogen, a C₁-Cl₉ aliphatic radical, a C₃-C₁₉ cycloaliphatic radical, or a C₃-C₁₉ aromatic radical. Typical amino acid compounds include, but not limited to, lysine, aminocaproic acid, glycine, glutamic acid, alanine, aspartic acid, tyrosine, serine, proline, valine, threonine, leucine, cycloleucine, nipecotic acid, pipecolinic acid, vigabatrin, aminobenzoic acid, 12-aminododecanoic acid, trans-4-(aminomethyl)cyclohexanecarboxylic acid, sarcosine, L-valine, and iminodiacetic acid and combinations thereof.

In another embodiment, the XQ moiety present in the polyarylate comprising structural units having formula II is a hydroxy group obtained by selective hydrolysis of the acid chloride end group of the polyarylate acid chloride with water. The hydrolysis can be effected under acidic or basic conditions. In one embodiment, an organic base, for example a tertiary amine (e.g. triethylamine) may be used to enhance the rate and/or selectivity of the hydrolysis reaction which provides a polyarylate comprising structural units having formula II wherein XQ is OH.

As noted, and as will be illustrated by the experimental examples presented herein, the polyarylate acid chloride polymers of the present invention may be prepared by the copolymerisation of a mixture comprising at least one dihydroxy aromatic compound, and at least one aromatic diacid halide. The reaction is effected by providing a first solution of at least one diacid chloride and at least one substantially water immiscible solvent. By substantially immiscible it is meant that in a two-phase solvent-water mixture comprising a water-rich aqueous layer and a solvent rich organic layer, the water-rich aqueous layer will comprise less than about 5 weight percent (wt. %) solvent, and in another embodiment less than about 2 wt. % solvent. Suitable organic solvents include dichloromethane, trichloroethylene, tetrachloroethane, chloroform, 1,2-dichloroethane, toluene, xylene, trimethylbenzene, chlorobenzene, o-dichlorobenzene, and mixtures thereof. In a particular embodiment the solvent is dichloromethane. An inert nitrogen or argon atmosphere may be maintained in the reactor, throughout the course of the reaction.

In certain embodiments where structural units derived from one or more aliphatic diols may also be present in the polyarylate acid chloride polymer, the first solution may also comprise the aliphatic diol.

In one embodiment, the first solution comprises an organic phase transfer catalyst. Suitable phase transfer catalysts are exemplified by tertiary amines, quaternary ammonium salts, quaternary phosphonium salts, hexaalkylguanidinium salts, and mixtures thereof. Suitable tertiary amines include triethylamine, dimethylbutylamine, diisopropylethylamine, dimethylethylamine, 2,2,6,6-tetramethylpiperidine, and mixtures thereof. Other contemplated tertiary amines include N—C₁-C₆-alkyl-pyrrolidines, such as N-ethylpyrrolidine, N—C₁-C₆-alkyl-piperidines, such as N-ethylpiperidine, N-methylpiperidine, and N-isopropylpiperidine, N—C₁-C₆-alkyl-morpholines, such as N-ethylmorpholine and N-isopropyl-morpholine, N—C₁-C₆-alkyl-dihydroindoles, N—C₁-C₆-alkyl-dihydroisoindoles, N—C₁-C₆-alkyl-tetrahydroquinolines, N—C₁-C₆-alkyl-tetrahydroisoquinolines, N—C₁-C₆-alkyl-benzomorpholines, 1-azabicyclo-[3.3.0]-octane, quinuclidine, N—C₁-C₆-alkyl-2-azabicyclo-[2.2.1]-octanes, N—C₁-C₆-alkyl-2-azabicyclo-[3.3.1]-nonanes, and N—C₁-C₆-alkyl-3-azabicyclo-[3.3.1]-nonanes, N,N,N′,N′-tetraalkylalkylene-diamines, including N,N,N′,N′-tetraethyl-1,6-hexanediamine. In various embodiments the tertiary amines triethylamine and/or N-ethylpiperidine are employed. Also included are 4,4-dimethylaminopyridine, 4-pyrrolidino pyridine and other 4,4-dialkylaminopyridines. Suitable quaternary ammonium salts include ammonium halide salts such as tetraethylammonium bromide, tetraethylammonium chloride, tetrapropylammonium bromide, tetrapropylammonium chloride, tetrabutylammonium bromide, tetrabutylammonium chloride, methyltributylammonium chloride, benzyltributylammonium chloride, benzyltriethylammonium chloride, benzyltrimethylammonium chloride, trioctylmethylammonium chloride, cetyldimethylbenzylammonium chloride, octyltriethylammonium bromide, decyltriethylammonium bromide, lauryltriethylammonium bromide, cetyltrimethylammonium bromide, cetyltriethylammonium bromide, N-laurylpyridinium chloride, N-laurylpyridinium bromide, N-heptylpyridinium bromide, tricaprylylmethylammonium chloride (sometimes known as ALIQUAT 336), methyltri-C₈-C₁₀-alkyl-ammonium chloride (sometimes known as ADOGEN 464), and N,N,N′,N′,N′-pentaalkyl-alpha, omega-amine-ammonium salts such as disclosed in U.S. Pat. No. 5,821,322. Suitable quaternary phosphonium salts are illustrated by tetrabutylphosphonium bromide, benzyltriphenylphosphonium chloride, triethyloctadecylphosphonium bromide, tetraphenylphosphonium bromide, triphenylmethylphosphonium bromide, trioctylethylphosphonium bromide, and cetyltriethylphosphonium bromide. Suitable hexaalkylguanidinium salts are illustrated by the hexaalkylguanidinium halides, hexaethylguanidinium chloride, hexaethylguanidinium bromide, hexaethylguanidinium fluoride, hexapropylguanidinium chloride, and the like, and mixtures thereof. While only species comprising halide anions as counter ions are expressly mentioned in the foregoing listing of suitable catalysts, almost any anionic species may serve as the counter ion in catalyst systems useful in the preparation of the polyarylate polymers of the present invention. For example, quaternary ammonium hydroxides, quaternary phosphonium hydroxides, and hexaalkylguanidinium hydroxides may be employed. In one embodiment, the catalyst is methyl tributyl ammonium hydroxide.

In one embodiment the amount of organic phase transfer catalyst present may be about 0.1 to 10 mole percent based on the total molar amount of acid chloride groups. In another embodiment the amount of catalyst present may be about 0.2 to 6 mole percent based on the total molar amount of acid chloride groups. In yet another embodiment the amount of catalyst present may be about 1 to 4 mole percent based on the total molar amount of acid chloride groups. In one particular embodiment the amount of catalyst present is about 2 to 4 mole percent based on the total molar amount of acid chloride groups.

The first solution is then contacted with an aqueous solution prepared from at least one dihydroxy aromatic compound and at least one metal hydroxide to provide a product mixture. Exemplary metal hydroxides that may be used in the reaction include, but are not limited to, lithium hydroxide, sodium hydroxide, potassium hydroxide, calcium hydroxide, rubidium hydroxide, magnesium hydroxide, cesium hydroxide, and the like. In one embodiment, a full stoichiometric equivalent of the metal hydroxide (based on the total moles of dihydroxy aromatic compound) is employed in the polymerization reaction. The dihydroxy aromatic compound is employed in an amount such that the acid chloride is present in stoichiometric excess. In one embodiment, the molar ratio of the at least one acid chloride to the at least one resorcinol compound is in a range of from about 1.1:1.0 to about 1.5:1.0.

The temperature of the polymerization reaction mixture may be any convenient temperature that provides a useful reaction rate. Convenient temperatures include those from about −20° C. to the boiling point of the water and water-immiscible organic solvent mixture under the reaction conditions. In one embodiment the reaction is performed at the boiling point of the organic solvent in the water-organic solvent mixture. In another embodiment the reaction is performed at the boiling point of dichloromethane. The time of reaction depends on the choice of the reactants and the temperature of the reaction and will become apparent to one skilled in the art.

The product mixture formed typically comprises a brine phase and an aqueous phase. In one embodiment, at the end of the reaction, the product mixture comprises two immiscible phases which are allowed to cool and separate. Subsequently, the brine phase is separated from the organic phase and discarded. The organic phase comprising the polyarylate acid chloride and the water immiscible solvent is retained. In one embodiment, the organic phase is subjected to solvent removal. Suitable solvent removal techniques include, but not limited to, distillation, air-drying, drum drying, devolatilizing extrusion, and the like. The polyarylate acid chloride obtained comprises acid chloride end groups. Other techniques for isolation of the polyarylate acid chloride may also be effected. Such techniques include, but are not limited to precipitation into a non-solvent, followed by filtration. Filtration includes sintered metal filtration, vacuum filtration, suction filtration, gravity filtration, decantation, and centrifugation.

The product polyarylate acid chloride having acid chloride end groups, as noted before, are characterized by an acid chloride value (ACV). The acid chloride value is typically determined by titration of the polyarylate with a suitable titrant using a suitable indicator to monitor the endpoint of the titration. Organic amine bases are especially suited for this purpose as they can react rapidly and selectively with the acid chloride groups of the product polyarylate acid chloride. In one embodiment, a primary amines is employed as the titrant. In another embodiment, a secondary amine is employed as the titrant. In yet another embodiment, a secondary amine and a tertiary amines (as an acid scavenger) is employed as the titrant. The endpoint of the titration may be monitored through the use of commercially available phosgene indicator test paper.

In one particular embodiment, the acid chloride value is determined by titrating an organic solution of the product polyarylate acid chloride with an aqueous solution of diisobutyl amine containing ethyldiisopropyl amine as an acid scavenger.

As noted, In one embodiment, the polyarylate acid chloride is further reacted with a nucleophile having structure VII to produce a polyarylate comprising structural units II. The reaction between the polyarylate acid chloride end groups and the nucleophile having structure VII may be conducted in an interfacial manner or in a homogeneous solution. In one embodiment, a product mixture comprising a polyarylate acid chloride is reacted directly with a nucleophile VII without isolation of the polyarylate acid chloride. In an alternate embodiment, the polyarylate acid chloride is isolated from the product mixture and purified, and thereafter reacted with a nucleophile in a suitable reaction medium.

As noted, the nucleophile VII may be an amino acid or a derivative thereof. Reaction of acid chloride functional groups with amino acid can be effected smoothly and in high yield, as a result of the very facile reaction of acid chloride groups with amino groups to give rise to an amide product. Stearically hindered secondary amine, such as diisobutylamine, are known to react very readily at room temperature with acid chlorides. In certain instances, however, the zwitterionic character and poor solubility in organic solvents of amino acids limit their utility. In one embodiment of the present invention, the amino acid is introduced in the form of a basic aqueous solution into a reactor containing a solution of a polyarylate acid chloride in a water immiscible solvent. Basic conditions may be necessary to ensure that the amino functionality of the amino acid is non-protonated and available for reaction with the acid chloride. Transfer of the amino acids or its carboxylate salt into the organic phase may limit reaction rates. The presence of a phase transfer catalyst and/or the use of organic bases may be used to enhance reaction rates. The identity of the amino acid may also affect the reaction rate. Relatively lipophilic amino acids, for example 12-aminododecanoic acid, are generally more soluble in organic solvents than low molecular weight hydrophilic amino acids, such as glycine. Additional ionic groups present in amino acids such as glutamic and aspartic acid, may also reduce the solubility of the amino acid in the organic phase and increase the solubility in water, thus further limiting reaction rates.

In interfacial reactions of polyarylate acid chlorides with water soluble nucleophiles, the rate at which the nucleophile is transferred into the organic layer may be especially important when water competes with the nucleophile to react with the acid chloride groups and ester linkages in the polyarylate backbone. Taking the interfacial reaction of a water soluble amino acid carboxylate with a polyarylate acid chloride comprising structural unit I as an example, it is noted that although significantly less nucleophilic than a free amino group, water as well as the carboxylate anion will also compete to react with acid chloride groups. Successful competition by water and/or the carboxylate moiety of the amino acid for acid chloride groups can lead to a number of side reactions, which may be undesirable.

In one embodiment, the nucleophile VII is a hydroxy acid or a derivative thereof. The reaction of the hydroxy group of a hydroxy acid with the acid chloride end groups of the polyarylate acid chloride results in an ester-capped polyarylate. The hydroxyl group is typically less nucleophilic than an amino group. Consequently, hydrolysis may be problematic in an interfacial reaction between a polyarylate acid chloride and a hydroxy acid or a derivative thereof, than in the corresponding interfacial reaction between a polyarylate acid chloride and an amino acid or a derivative thereof. In certain instances, however, the hydroxy acids and/or their derivatives exhibit better solubility in the organic phase than an amino acid of similar molecular weight, a circumstance which allows more facile ester-capping process preparation of an ester-capped polyarylate. In one embodiment, end-capping of a polyarylate acid chloride with hydroxy acids may be performed in the absence of water in homogenous solution.

In various embodiments of the present invention, the polyarylate acid chloride is reacted with a nucleophile which results in a functionalized polyarylate comprising an electrophilic or a nucleophilic functional group. For example, the polyarylate acid chloride may be reacted with isothiocyante anion to provide an electrophilic polyarylate species comprising structural unit II wherein moiety XQ is the isothiocyanate group —N═C═S. Alternatively, the polyarylate acid chloride may be reacted with an aliphatic diamine such as hexamethylene diamine anion to provide a nucleophilic polyarylate species comprising structural unit II wherein moiety XQ is the —NH—(CH₂)₆—NH₂ group. In yet another embodiment, embodiment the nucleophile BXQ having structure VII comprises a C₃-C₂₀ aliphatic or cycloaliphatic radical comprising at least one epoxy group. Thus, in one particular embodiment, BXQ is glycidyl alcohol. In another embodiment BXQ is 3-cyclohexenylmethanol epoxide.

In one embodiment, the end-capped polyarylate comprising structural unit II is isolated by removing the solvent from a solution of the end-capped polyarylate. Suitable solvent removal techniques include, but are not limited to, distillation, air-drying, drum drying, devolatilizing extrusion, and the like. Other techniques for isolation of the end-capped polyarylate may also be effected. Such techniques include, but are not limited to precipitation into a non-solvent, followed by filtration. Filtration include sintered metal filtration, vacuum filtration, suction filtration, gravity filtration, decantation and centrifugation.

Experimental Section

The following examples are intended only to illustrate methods and embodiments in accordance with the invention, and as such should not be construed as imposing limitations upon the claims. The following chemicals were obtained from the indicated suppliers: resorcinol from Indspec Chemical Corporation; isophthaloyl chloride (IPC) and terephthaloyl chloride (TPC) from Twin Lake Chemicals; triethylamine (TEA) from Avocado Research Chemicals; sodium hydroxide solution (50%), potassium hydroxide solution (45%), sulfuric acid, hydrochloric acid, and methylene chloride from J. T. Baker; CAPA 2054, a polycaprolactone diol (initiated with diethylene glycol) having an average molecular weight of 530 grams per mole was obtained from Solvay. All other chemicals were obtained from Aldrich Chemicals, Milwaukee, Wis., USA. At times, for convenience, to avoid handling solid iso-and terephthaloyl chlorides, a stock solution was prepared in methylene chloride, the stock solution containing a 1:1 mixture of isophthaloyl chloride and terephthaloyl chloride. Molecular weights were determined by gel permeation chromatography using chloroform as the eluent, and polystyrene molecular weight standards. Acid equivalent weight was determined by titration according to method described in ASTM standard test method D 1639-90.

Experimental Set-Up

The reactor was equipped with a stirrer, condenser, addition funnel, pH-meter, inlet pump, nitrogen inlet, and bubbler. The pH-meter was calibrated with standard solutions (pH=4, 7, and 10) before each run. The aqueous resorcinol/sodium hydroxide solution was prepared and maintained under a nitrogen atmosphere in an addition vessel, which was connected to the addition pump.

### EXAMPLE 1

Into a closed container 1, 0.46 grams (g) of triethylamine (TEA) and 5 milliliters (ml) of methylene chloride were added and the contents were shaken or stirred briefly. In container 2, 50% NaOH solution (26 g) was carefully mixed with deionized (DI) water (17.16 ml). For safety reasons the NaOH should be added cautiously portion-wise to the water. Container 2 was maintained under a nitrogen atmosphere. Subsequently, resorcinol (16.8 g) was added slowly to the NaOH solution under agitation and the agitation was continued until a clear solution comprising the sodium salt of resorcinol was obtained.

A mixture of isophthaloyl chloride (47.75 g, 376 millimoles (mmol)), and terephthaloyl chloride (47.75 g, 376 mmol) was added into the reactor as a 40% stock solution in methylene chloride, followed by 180 milliliters (ml) of methylene chloride. The contents of the reactor were stirred under nitrogen until a clear solution was obtained. CAPA 2054 (8 g, 30.2 mmol) was added just prior to the start of the reaction while stirring. The stirrer speed was increased to maximize agitation without significant splashing. Then the TEA solution from container 1 was added rapidly to the reactor. Measurement of the reaction mixture pH was started. Then, the resorcinol disodium salt solution addition from container 2 was commenced at a rate of 3 ml/minute (addition time approx. 10-15 minutes). The ensuing reaction was exothermic and resulted in methylene chloride reflux. The addition vessel (container 2) was rinsed with approximately 7 ml of water, which was subsequently added to the reactor. After addition was completed, the reaction mixture was stirred for a further 30 minutes. The methylene chloride layer contained the product polyarylate acid chloride which was characterized as follows.

The density of the methylene chloride layer as well as the percent solids was determined by standard techniques (weighing 10 ml of solution and evaporation of 10 ml of solution to constant weight in a vacuum oven at 40° C.). 10 ml (13.1 g) of the methylene chloride layer was titrated with a 0.1002 M solution of diisobutylamine (DIBA), which also contained 0.1006 M ethyldiisopropylamine as an acid scavenger. The endpoint of the titration was checked against phosgene indicator paper. A negative response to the phosgene indicator paper indicated that essentially all of the acid chloride groups present in the product polyarylate acid chloride had reacted with the diisobutylamine.

The acid chloride equivalent weight (also referred to herein as the “acid chloride value” or “ACV”) in microequivalents per gram was then determined by the following equation:

$$ACV = \frac{\begin{matrix}( DIBA Concentration in microequivalents per ml ) * \\ ( mL of DIBA solution )\end{matrix}}{\begin{matrix}( ml product acid chloride solution ) * \\ ( density of product acid chloride solution ) * ( \% solids )\end{matrix}}$$

wherein the DIBA concentration is given in micromoles (microequivalents) per milliliter, “ml product acid chloride solution” refers to the volume of a test aliquot of the product acid chloride to be titrated, the “density of product acid chloride solution” is the weight in grams of the test aliquot of the product polyarylate acid chloride solution divided by its volume (in ml), and “percent solids” is the percent solids content of the product polyarylate acid chloride solution determined by drying a known weight of the product polyarylate acid chloride solution to dryness.

The weight average molecular weight M_{w} of the product polyarylate acid chloride was found to be 7400 grams per mole, while the number average molecular weight Mₙ was found to be 2200. The acid chloride value was determined to be 700 micro equivalents per gram.

### EXAMPLE 2

A procedure nearly identical to that employed in Example 1 was followed, with the exception that no CAPA was used. The molar ratio of acid chloride groups to hydroxy groups was the same as that used in Example 1. The yield, purity and molecular weight of product polymer were essentially the same, however, the product polyarylate acid chloride contained no structural units derived from CAPA. The acid chloride value for the product polyarylate acid chloride was determined as described in Example 1 and was found to be 950 micro equivalents per gram.

### EXAMPLE 3

Into a closed “container 1”, 72 grams (g) of TEA and 0.5 liters (L) of methylene chloride were added and the contents were stirred briefly. In a “container 2”, 50% NaOH solution (4200 g) was carefully mixed with distilled deionized (DI) water (2.4 L). For safety reasons the NaOH should be added cautiously, portion-wise to the water. “Container 2” was maintained under a nitrogen atmosphere and resorcinol (2688 g) was added slowly under agitation, and the agitation was continued until a clear solution was obtained. Into a closed “container 3”, 5-hydroxyisophthalic acid (1120 g) and pyridine (4500 g) were added. The contents of “container 3” were stirred until a clear solution was obtained.

The reactor was charged with isophthaloyl chloride (3000 g, 29.5 mole equivalents), terephthaloyl chloride (3000 g, 29.5 mole equivalents) and 30 liters (L) of methylene chloride, and the contents of the reactor were stirred under nitrogen until a clear solution was obtained. CAPA 2054 (1280 g, 4.8 mole equivalents) was added just prior to the start of the reaction while stirring. The stirrer speed was adjusted to maximize agitation without significant splashing. Then the solution from “container 1” was added rapidly to the reactor. Measurement of the reaction mixture pH was started. Then, the addition of the resorcinol disodiun salt solution from “container 2” was commenced (addition time approx. 20 minutes—exothermic, resulting in methylene chloride reflux). After the addition was completed, the reaction mixture was stirred for a further 30 minutes. Then, approximately 5 L of water was added and the stirrer was turned off; the methylene chloride phase was recovered and brine phase was discarded. The methylene chloride was returned to the reactor and the contents of “container 3” were added quickly and the reaction mixture was stirred for 1 hour (h). Isopropyl alcohol (IPA, 12 L) was added (˜⅓ of methylene chloride volume) under stirring. After the addition was complete, the stirring was stopped and 15 L of water was added. Then, the mixture was acidified with 2 molar (M) sulfuric acid (approximately 20 liters) until the pH was 1. The reaction mixture was stirred gently and the phases were allowed to separate for 1 hour before the methylene chloride phase was recovered. The layers were separated and the aqueous layer was discarded. The methylene chloride phase was returned to the reactor and IPA (8 L) was added. The resultant solution was then washed with water (30 L) acidified to pH 1 with sulfuric acid (approximately 200 milliliters 2M sulfuric acid). The mixture was stirred gently and the phases were allowed to separate for 1 hour and the methylene chloride phase was recovered and the aqueous phase was discarded. This step was repeated a second time. The methylene chloride phase was then evaporated to dryness to afford approximately 4.5 kilogram of a slightly yellow, glassy product polymer comprising terminal groups derived from 5-hydroxyisophthalic acid and having a weight average molecular weight (M_{w}) of 3700 grams per mole, a glass transition temperature of 55° C. and a carboxylic acid value (determined analogously to the acid chloride value) of 570 microequivalents per gram.

### EXAMPLE 4

A procedure nearly identical to that employed in Example 3 was followed, with the exception that the end-capping agent used was 6-aminocaproic acid instead of 5-hydroxyisophthalic acid. The yield, purity and molecular weight of product polymer were essentially the same. The carboxylic acid value was found to be 895 microequivalents per gram.

### EXAMPLE 5

A procedure nearly identical to that employed in Example 3 was followed, with the exception that the end-capping agent used was water. The yield, purity and molecular weight of product polymer were essentially the same. The carboxylic acid value was found to be 1070 microequivalents per gram.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A polyarylate acid chloride comprising at least one arylate structural unit having formula I 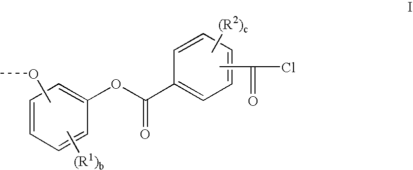
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate having a number average molecular weight in a range form about 500 to about 4000 grams per mole, said polyarylate having an acid chloride value in a range from about 500 to about 2000 microequivalents per gram.

2. The composition according to claim 1, wherein the number average molecular weight is a range of from about 500 to about 3000 grams per mole.

3. The composition according to claim 1, wherein the number average molecular weight is in a range of from about 500 to about 2500 grams per mole.

4. A composition comprising structural units derived from a polyarylate acid chloride having formula I 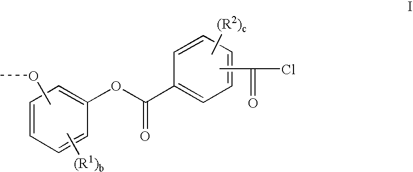
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate acid chloride having a weight average molecular weight in a range form about 500 to about 4000 grams per mole, said polyarylate having an acid chloride value in a range from about 500 to about 2000 micro equivalents per gram.

5. The composition according to claim 4 said composition comprising structural units having formula II 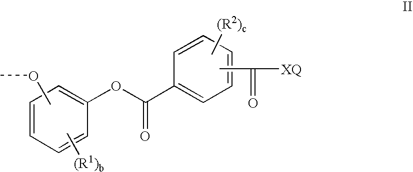
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical, “b” and “c” are independently integers having a value 0 to 4; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, CN, OH, OOH, NCO, or NCS; and R³ is a C₁-C₂₀ aliphatic radical, a C₃-C₂₀ cycloaliphatic radical, or a C₂-C₂₀ aromatic radical.

6. The composition according to claim 5, where XQ has formula III 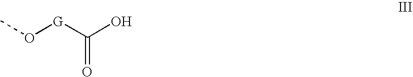
wherein G is a C₁-C₂₀ aliphatic radical, a C₃-C₂₀ cycloaliphatic radical, or a C₂-C₂₀ aromatic radical.

7. The composition according to claim 6, wherein XQ is derived from at least one hydroxy acid selected from the group consisting of 5-hydroxyisophthalic acid, 4-hydroxybenzoic acid, salicylic acid, hydroxy caproic acid, lactic acid, and combinations thereof.

8. The composition according to claim 6, where XQ has formula IV

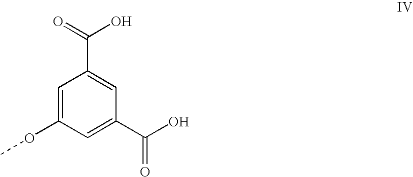

9. The composition according to claim 5, where XQ has formula V 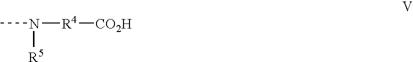
wherein R⁴ is a divalent C₁-C₂₀ aliphatic radical, a divalent C₃-C₂₀ cycloaliphatic radical, or a divalent C₃-C₂₀ aromatic radical; and R⁵ is hydrogen, a monovalent C₁-C₂₀ aliphatic radical, a monovalent C₃-C₂₀ cycloaliphatic radical, or a monovalent C₃-C₂₀ aromatic radical.

10. The composition according to claim 9, wherein R⁴ has formula VI 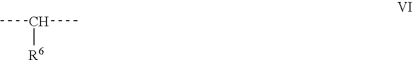
wherein R⁶ is hydrogen, a C₁-C₁₉ aliphatic radical, a C₃-C₁₉ cycloaliphatic radical, or a C₃-C₁₉ aromatic radical.

11. The composition according to claim 9, wherein the moiety XQ is derived from at least one amino acid selected from the group consisting of lysine, aminocaproic acid, glycine, glutamic acid, alanine, aspartic acid, and combinations thereof.

12. A method for preparing a polyarylate acid chloride comprising structural units I 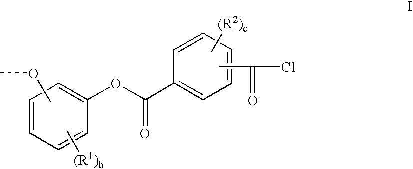
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; said polyarylate having a weight average molecular weight in a range form about 500 to about 4000 grams per mole, said polyarylate having an acid chloride value in a range from about 500 to about 2000 micro equivalents per gram;
said method comprising:
(a) providing a first solution of at least one diacid chloride, an organic phase transfer catalyst, and at least one substantially water immiscible solvent;
(b) contacting said first solution with an aqueous solution comprising at least one dihydroxy aromatic compound and at least one metal hydroxide, said at least one dihydroxy aromatic compound being used in an amount such that the at least one diacid chloride is in stoichiometric excess relative to the amount of the dihydroxy aromatic compound used, said metal hydroxide being used in an amount corresponding to a stoichiometric excess relative to the amount of the dihydroxy aromatic compound used, to provide a product mixture said product mixture comprising a brine phase and an organic phase; and
(c) separating said brine phase and said organic phase to provide a solution of the product polyarylate acid chloride.

13. The method according to claim 12, wherein the first solution further comprises at least one aliphatic diol.

14. A method for preparing an end-capped polyarylate composition comprising structural units II 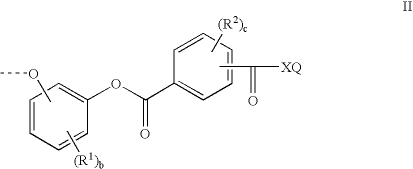
wherein R¹ and R² are independently at each occurrence a halogen atom, a nitro group, a C₁-C₂₀ aliphatic radical, a C₃-C₂₀ cycloaliphatic radical, or a C₃-C₂₀ aromatic radical; “b” and “c” are independently integers having a value 0 to 4; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, CN, OH, OOH, NCO, or NCS; and R³ is a C₁-C₂₀ aliphatic radical, a C₃-C₂₀ cycloaliphatic radical, or a C₂-C₂₀ aromatic radical;
said method comprising:
(a) providing a first solution of at least one diacid chloride, an organic phase transfer catalyst, and at least one substantially water immiscible solvent;
(b) contacting said first solution with an aqueous solution comprising at least one dihydroxy aromatic compound and at least one metal hydroxide, said at least one dihydroxy aromatic compound being used in an amount such that the at least one diacid chloride is in stoichiometric excess relative to the amount of the dihydroxy aromatic compound used, said metal hydroxide being used in an amount corresponding to a stoichiometric excess relative to the amount of the dihydroxy aromatic compound used, to provide a product mixture said product mixture comprising an brine phase and an organic phase;
(c) separating said brine phase and said organic phase to provide a solution of the product polyarylate acid chloride, said polyarylate acid chloride having a weight average molecular weight in a range form about 500 to about 4000 grams per mole, said polyarylate having an acid chloride value in a range from about 500 to about 2000 micro equivalents per gram; and
(d) contacting said polyarylate acid chloride with at least one nucleophile having structure VII
BXQ VII
wherein B is a negative charge, H, or (R⁷)₃Si; X is a bond, S, Se, O, NH, NR³, a divalent C₁-C₂₀ aliphatic radical, a divalent C₃-C₂₀ cycloaliphatic radical, or a divalent C₂-C₂₀ aromatic radical; Q is hydrogen, a C₁-C₂₀ aliphatic radical, a C₃-C₂₀ cycloaliphatic radical, a C₂-C₂₀ aromatic radical, a polymer chain, NH₂, CN, OH, OOH, NCO, or NCS; R³ is a C₁-C₂₀ aliphatic radical, a C₃-C₂₀ cycloaliphatic radical, or a C₂-C₂₀ aromatic radical; and R⁷ is independently at each occurrence a C₁-C₂₀ aliphatic radical, a C₃-C₂₀ cycloaliphatic radical, or a C₂-C₂₀ aromatic radical.

15. The method according to claim 14, wherein the first solution further comprises an aliphatic diol.

16. The method according to claim 14, wherein the contacting of step (d) is carried out under interfacial conditions.

17. The method according to claim 14, wherein the contacting of step (d) is carried out in a single-phase reaction mixture.

18. The method according to claim 14, wherein the nucleophile BXQ is a phenolate anion.

19. The method according to claim 14, wherein the nucleophile BXQ is an amine.

20. The method according to claim 14, wherein the nucleophile BXQ is glycidyl alcohol.

21. The method according to claim 14, wherein the nucleophile BXQ is cyclohexenyl methanol epoxide.

22. The method according to claim 14, wherein the nucleophile BXQ is a hydroxy substituted polymer.

23. The method according to claim 22, wherein said hydroxy substituted polymer is a polyether.
